(19) United States
(12) Patent Application Publication
(10) Pub. No.: US 2011/0280175 A1
(43) Pub. Date: Nov. 17, 2011

(54) WIRELESS RELAY DEVICE

(75) Inventors: Daisuke Yamada, Nagoya-shi (JP); Hainian Song, Nagoya-shi (JP); Tomoaki Ohara, Nagoya-shi (JP)

(73) Assignee: BUFFALO INC., Nagoya-shi (JP)

(21) Appl. No.: 13/106,883

(22) Filed: May 13, 2011

(30) Foreign Application Priority Data
May 14, 2010 (JP) 2010-111781

(51) Int. Cl. H04B 7/14; H04W 84/02

(52) U.S. Cl. 370/315

(57) ABSTRACT

A switch switches between an external connection state where a port functions as an external-network-side port, and an internal connection state where the port functions as an internal-network-side port. A transfer process section transfers, when the switch is in the external connection state, a packet between a station belonging to a wirelessly connected internal network and a modem wiredly connected to the port, and otherwise transfers, when the switch is in the internal connection state, a packet between a station wiredly connected to the port and a network device belonging to a wirelessly connected external network.

### CROSS REFERENCE TO RELATED APPLICATION

The disclosure of Japanese Patent Application No. 2010-111781, filed on May, 14, 2010, is incorporated herein by reference.

### BACKGROUND OF THE INVENTION

1. Field of the Invention

The present invention relates to wireless relay devices for carrying out communications relaying processes in wireless communications networks.

2. Description of the Background Art

In homes or offices, in order to connect stations, such as personal computers and game machines, that are on a wireless or wired LAN (Local Area Network) to other networks, access points functioning as a wireless relay device are widely used (see, for example, Japanese Laid-Open Patent Publication No. 2005-142907). Portable access points have been proposed as access points of this sort, for enabling network connection wirelessly in away locations.

With portable access points, because smaller-sized casings are desirable, a configuration in which, for example, only a single port for connection with a network cable is furnished is often adopted. With respect to access points of this sort, provided with just a single port, there are demands from users wanting to use the port not only as an external-network-side port, for connection with a WAN (Wide Area Network) or the Internet, but also as an internal-network-side port, for connection with devices (e.g., clients and network switches) making up a LAN. Thus, the development of technology for using the lone port that the access points provide not only as an external-network-side port but also as an internal-network-side port is a forthcoming issue. At present, however, technology serviceable for using the lone port that the access points provide both as an external-network-side port and as an internal-network-side port has yet to be realized.

It should be noted that problems of this sort have of course also existed for access points furnished with a plurality of ports, in that if each port is considered singly, situations in which each port is to be used as an external-network-side port as well as an internal-network-side port may arise. In addition, problems of this sort are not limited to wireless relay devices that function as a wireless LAN access point, but have been common to wireless relay devices for carrying out wireless communications over any given wireless communications network.

### SUMMARY OF THE INVENTION

An object of the present invention, brought about to resolve the above-described problems, is to make available a wireless relay device in which a solely provided port is rendered usable both as an external-network-side port and an internal-network-side port.

The present invention is directed to a wireless relay device communicable with an internal network to which one or more stations belong and with an external network to which the stations do not belong. The wireless relay device of the present invention includes: a port for connection with a network cable; a switch for switching between an external connection state in which the port is used as a port on the external-network side, and an internal connection state in which the port is used as a port on the internal-network side; and a transfer process section for switching packet transfer operations in accordance with the state of the switch.

The wireless relay device further includes an internal-network-side wireless communications interface, belonging to the internal network, for carrying out wireless communications with one or more stations. The transfer process section is configured to operate, when the switch is in the external connection state, in a first operation mode, in which the transfer process section carries out packet transfer between a station as being connected to the wireless relay device via the internal-network-side wireless communications interface, and a network device belonging to the external network and connected to the port via a network cable, and operate, when the switch is in the internal connection state, in a second operation mode, in which the transfer process section carries out packet transfer between the wireless relay device and a station as being connected to the port via a network cable.

Further, the wireless relay device further includes an external-network-side wireless communications interface, belonging to the external network, for carrying out wireless communications with a network device belonging to a predetermined wireless communications network. The transfer process section may carry out packet transfer, in the second operation mode, between a station as being connected to the port via a network cable, and a network device connected to the wireless relay device via the external-network-side wireless communications interface. Examples of the predetermined wireless communications network include a public wireless LAN and a mobile communications network.

The wireless relay device may be configured with a main unit and an attachment detachably connectable to the main unit. In this configuration, the internal-network-side wireless communications interface and the external-network-side wireless communications interface are disposed in the main unit, and the port and the switch are disposed in the attachment. In addition, in this configuration, the wireless relay device may further include a determination section for determining whether the main unit is connected to the attachment. Preferably, the transfer process section operates, when the determination section determines that the main unit is not connected to the attachment, in a third operation mode in which the transfer process section transfers a packet between a station as being connected to the wireless relay device via the internal-network-side wireless communications interface, and a network device connected to the wireless relay device via the external-network-side wireless communications interface.

It should be noted that the present invention may be realized in various modes, and for example, may be realized by a wireless relay device, a wireless communications system including the wireless relay device, a method for controlling the device or the system, a computer program for realizing the method, or the function of the device or the system, a storage medium having the computer program stored therein, and the like.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is external views illustrating the front side and the rear side of an example of a wireless relay device 10 according the present invention;

FIG. 2 is external views illustrating the lateral sides of the wireless relay device 10;

FIG. 3 is external views illustrating the top side of the wireless relay device 10 and a cradle 200;

FIG. 4 is a functional block diagram illustrating the internal configuration of the wireless relay device 10;

FIG. 5 is a flowchart showing the procedure of an operation-mode switching process carried out by the wireless relay device 10 according to a first embodiment;

FIG. 6 is a diagram illustrating the wireless relay device 10 carrying out wireless communications using a first connection type;

FIG. 7 is a diagram illustrating the wireless relay device 10 carrying out wireless communications using a second connection type;

FIG. 8 is a diagram illustrating the wireless relay device 10 carrying out wireless communications using a third connection type;

FIG. 9 is a diagram illustrating the wireless relay device 10 carrying out wireless communications using a fourth connection type;

FIG. 10 is a diagram schematically illustrating a packet transfer path in the wireless relay device 10 using the first connection type illustrated in FIG. 6;

FIG. 11 is a diagram schematically illustrating a packet transfer path in the wireless relay device 10 using the second connection type illustrated in FIG. 7;

FIG. 12 is a diagram schematically illustrating a packet transfer path in the wireless relay device 10 using the third connection type illustrated in FIG. 8;

FIG. 13 is a diagram schematically illustrating a packet transfer path in the wireless relay device 10 using the fourth connection type illustrated n FIG. 9;

FIG. 14 is a flowchart showing the procedure of an operation-mode switching process carried out by the wireless relay device 10 according to a second embodiment;

FIG. 15 is a diagram illustrating the wireless relay device 10 carrying out wireless communications using a fifth connection type; and

FIG. 16 is a diagram schematically illustrating a packet transfer path in the wireless relay device 10 using the fifth connection type illustrated in FIG. 15.

### DESCRIPTION OF THE PREFERRED EMBODIMENTS

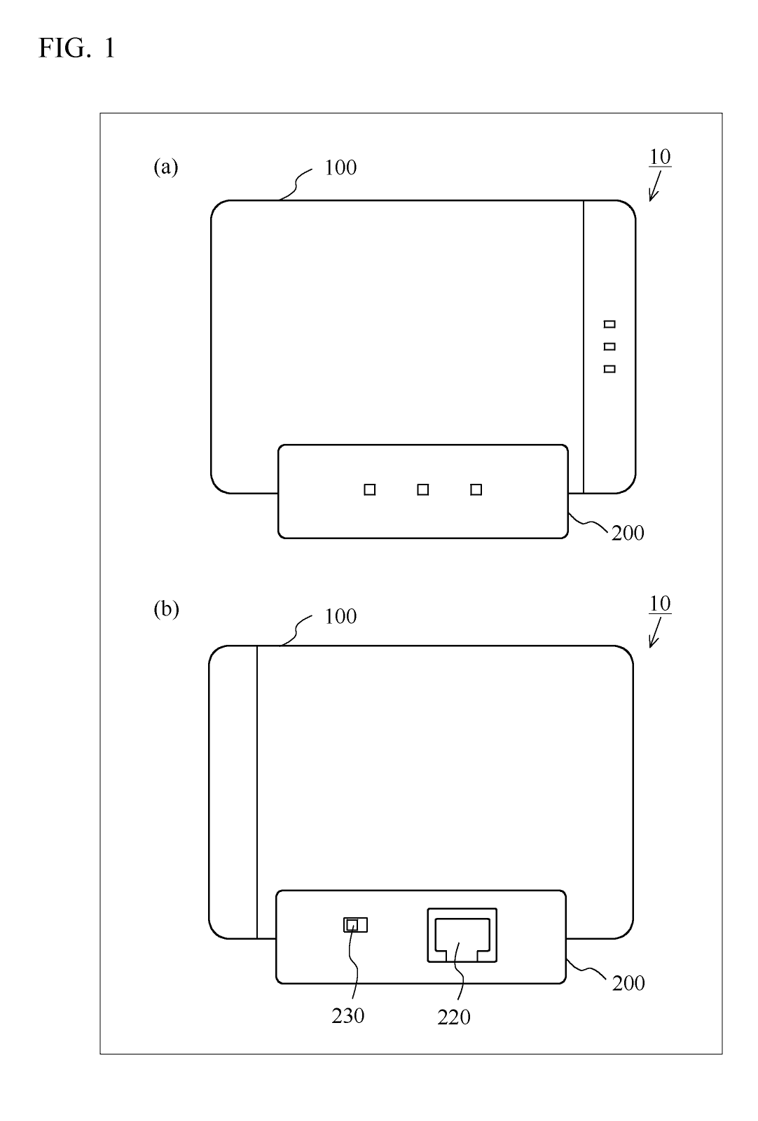

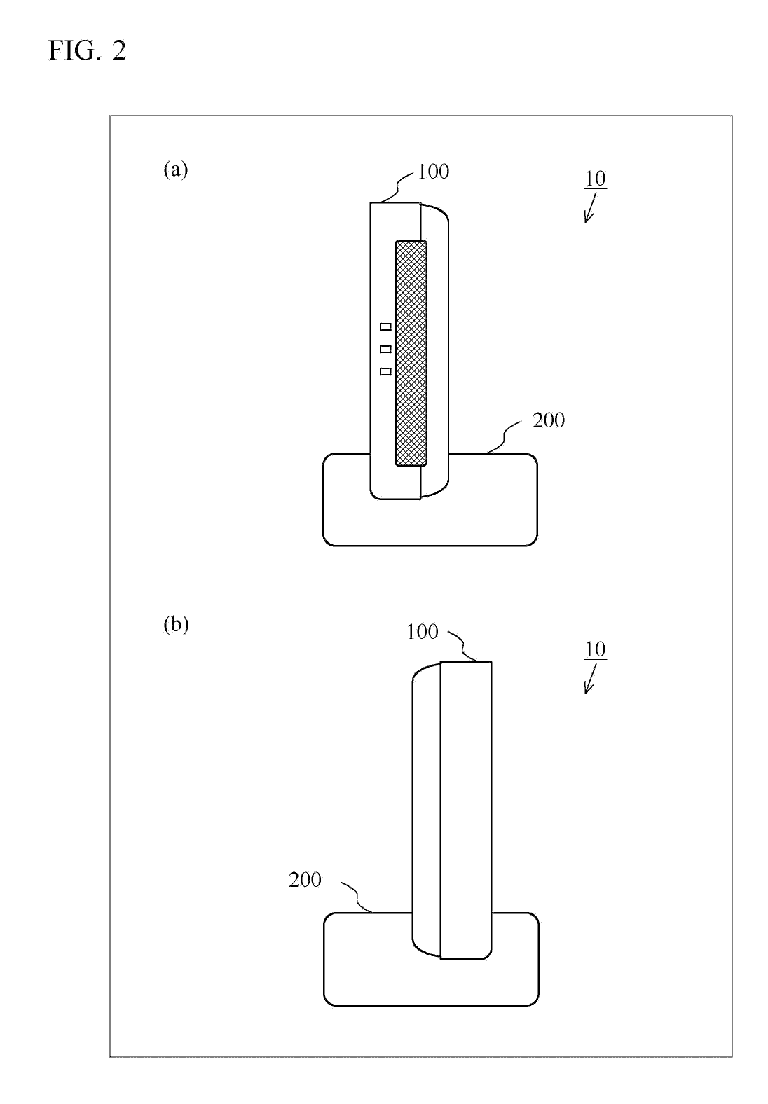

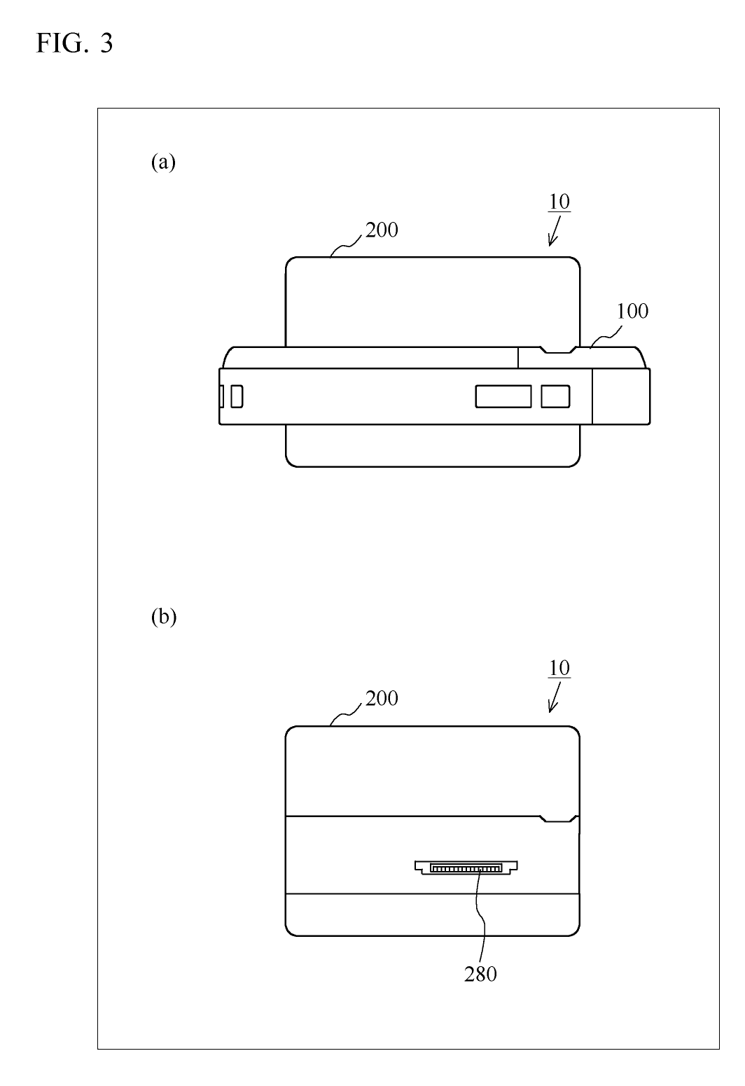

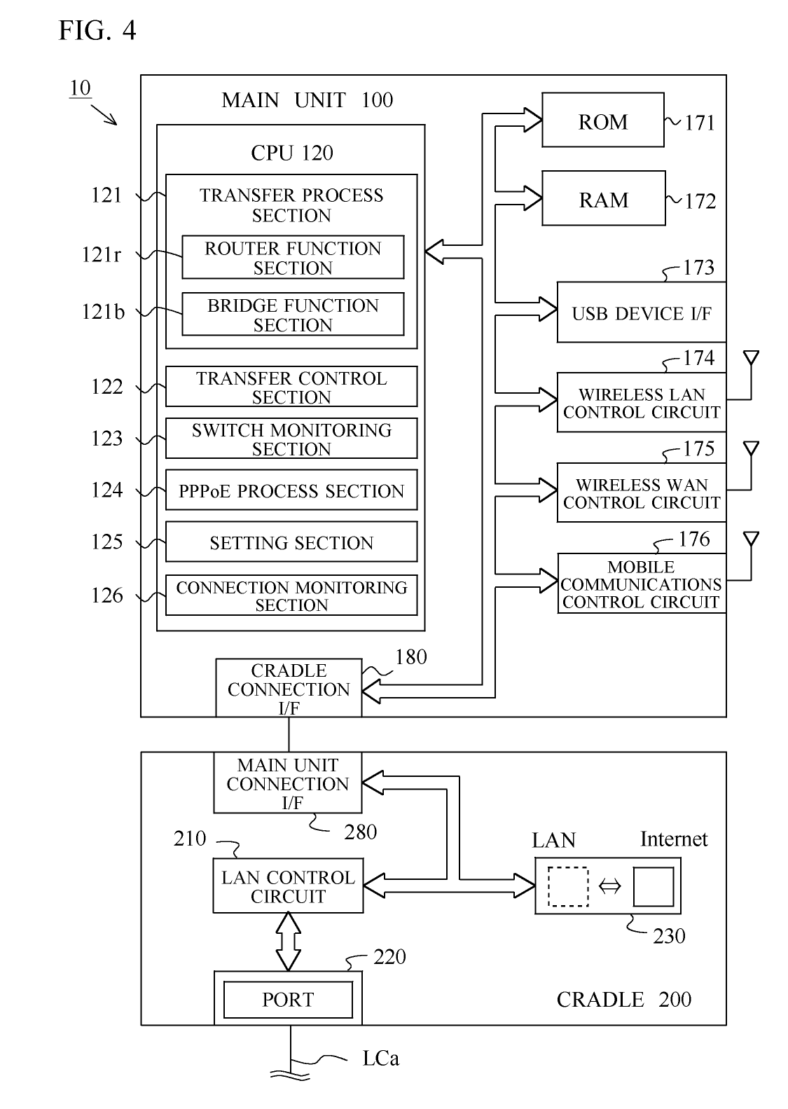

FIGS. 1 to 4 illustrate an example of the general configuration of a wireless relay device 10 according to the present invention. Diagrams (a) and (b) in FIG. 1 are external views illustrating the front side and the rear side of the wireless relay device 10, respectively. Diagrams (a) and (b) in FIG. 2 are external views illustrating lateral sides of the wireless relay device 10. Diagram (a) in FIG. 3 is an external view illustrating the top side of the wireless relay device 10, and diagram (b) in FIG. 3 is an external view illustrating the top side of a cradle 200 included in the wireless relay device 10. FIG. 4 is a functional block diagram illustrating the internal configuration of the wireless relay device 10.

To begin with, an outline of the components of the wireless relay device 10 according to the present invention will be described. An example of the wireless relay device 10 includes a main unit 100 and the cradle 200, which are detachably connectable to each other. The main unit 100 is a small, lightweight, transportable device, and is capable of performing the pivotal functions necessary to wireless relay processes. When connected to the main unit 100, the cradle 200 endows the main unit 100 with various functions. In addition, the cradle 200 also functions as a stand for cradling the main unit 100.

As illustrated in diagram (b) of FIG. 1, in diagram (b) of FIG. 3, and in FIG. 4, the cradle 200 includes a port 220 compliant, for example, with the IEEE 802.3/3u standard, a switch 230, a main unit connection interface (I/F) 280 for connection with the main unit 100, and a LAN control circuit 210 which is compliant with a predetermined network protocol (e.g., Ethernet) and controls data transfer via the port 220.

The switch 230 is a so-called slide switch, and located near the port 220. The switch 230 selectively switches between an “Internet” state and a “LAN” state in conformance with a manual setting by a user or other operator. In the example illustrated in FIG. 4, the switch 230 is set to the “Internet” state. The switch 230 switches the operation modes of a later-described transfer process section 121 in the main unit 100. Also, operation-mode switching in the transfer process section 121 will be described later.

The main unit connection interface 280 is capable of functioning as a USB device controller, for example, and, when the cradle 200 is connected to the main unit 100, enables transmission/reception of information, such as communications data and various control data, to/from the main unit 100, in accordance with the USB standard.

As illustrated in FIG. 4, the main unit 100 includes a CPU 120, which is a processor, a ROM 171, a RAM 172, a USB device interface (I/F) 173 for connection with a USB device, a wireless LAN control circuit 174, a wireless WAN control circuit 175, a mobile communications control circuit 176, and a cradle connection interface (I/F) 180 for connection with the cradle 200.

The wireless LAN control circuit 174 includes a modulator, an amplifier, and an antenna, and as an interface with wireless LAN access points compliant with, e.g., the IEEE 802.11b/g standard, performs wireless communications with stations (personal computers and game machines, for example) that are wireless LAN clients. Similarly, the wireless WAN control circuit 175 includes a modulator, an amplifier, and an antenna, and as an interface with stations that are wireless LAN clients compliant with, e.g., the IEEE 802.11a/b/g standard, performs wireless communications with access points (e.g., public wireless LAN terminals) on the WAN (Wide Area Network) side (e.g., public wireless LANs). Similarly, the mobile communications control circuit 176 includes a modulator, an amplifier, and an antenna, and as an interface with user equipment in mobile communications compliant with, for example, the 3G/HSPA (Third Generation/High Speed Packet Access) standard performs wireless communications with access points (e.g., mobile communications base stations) in mobile communications networks. As described above, the main unit 100 of the present invention is configured to perform wireless communications over multiple different wireless communications networks. In other words, the wireless LAN control circuit 174, the wireless WAN control circuit 175, and the mobile communications control circuit 176 function as multiple wireless communications interfaces compliant with the corresponding standards.

The cradle connection interface 180 functions as a USB host controller, and transmits/receives information to/from the cradle 200 in accordance with the USB standard when the main unit 100 is connected to the cradle 200.

The CPU 120 controls the respective components of the wireless relay device 10 by extracting into the RAM 172 firmware or a computer program stored in the ROM 171 and executing the firmware or the program, and also functions as a transfer process section 121, a transfer control section 122, a switch monitoring section 123, a PPPoE process section 124, a setting section 125, and a connection monitoring section 126.

The transfer process section 121 includes a router function section 121r and a bridge function section 121b, and transfers packets (Layer 3 packets and Layer 2 frames) via the wireless communications interfaces (wireless LAN control circuit 174, wireless WAN control circuit 175, and mobile communications control circuit 176) and via the port 220 of the cradle 200. The transfer control section 122 controls the transfer process section 121.

The switch monitoring section 123 monitors the switching state of the switch 230. Monitoring of the switching state can be performed by, for example, connecting the switch 230 and a GPIO (General Purpose Input/Output) port of the CPU 120 by means of a control line (not shown) and inputting interrupt signals to the CPU 120 via the control line.

The PPPoE process section 124 encapsulates IP (Internet Protocol) packets in accordance with PPPoE (PPP over Ethernet), which is standardized by the IETF (Internet Engineering Task Force), for user authentication and the like.

The setting section 125 sets various parameters for the main unit 100. Examples of the different parameters include IP address, SSID (Service Set Identifier), WEP (Wired Equivalent Privacy) key, and information on the Internet connection subscription (user name and password).

The connection monitoring section 126 is a functional section that monitors whether the main unit 100 is connected to the cradle 200. This monitoring of the connection state can be performed, for example, by checking whether power flows between the cradle connection interface 180 and the main unit connection interface 280.

The above-described cradle 200 is an example of the attachment recited in the claims. The wireless LAN control circuit 174 is an example of the internal-network-side wireless communications interface recited in the claims, the wireless WAN control circuit 175 and the mobile communications control circuit 176 correspond to an external-network-side wireless communications interface, and the transfer control section 122 and the connection monitoring section 126 are an example of the determination section recited in the claims.

### (1) First Embodiment

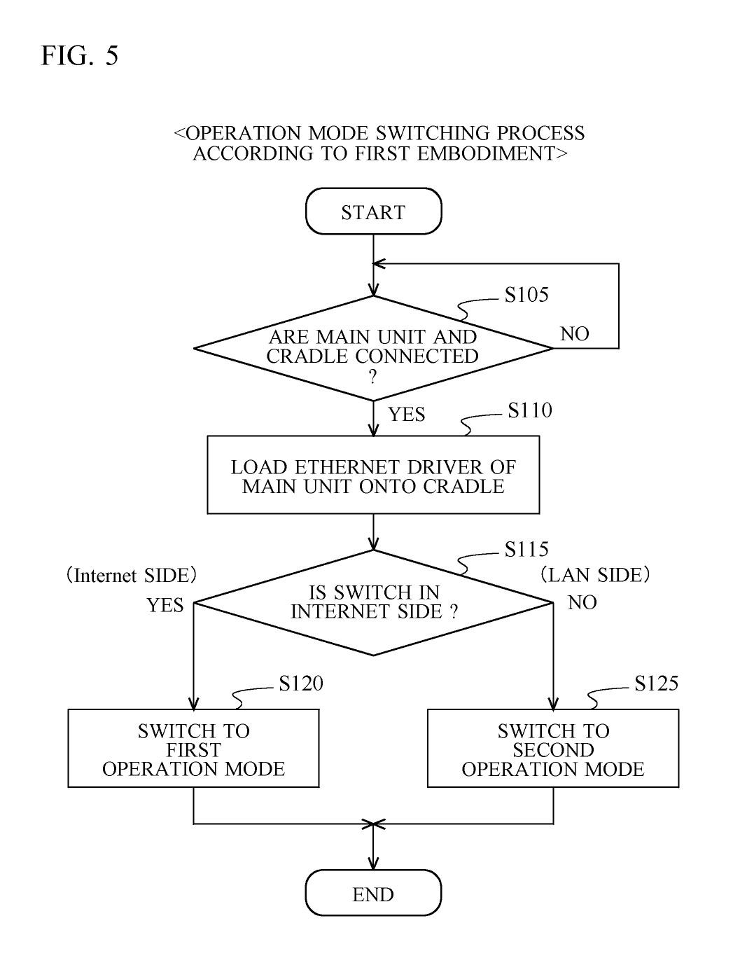

Next, an operation-mode switching process performed by the wireless relay device 10 having the above exemplified configuration will be described. The operation-mode switching process contemplated by the present invention may be embodied by first and second embodiments. Hereinafter, the operation-mode switching process according to the first embodiment will be described. FIG. 5 is a flowchart representing a procedure for the operation-mode switching process performed by the wireless relay device 10 according to the first embodiment.

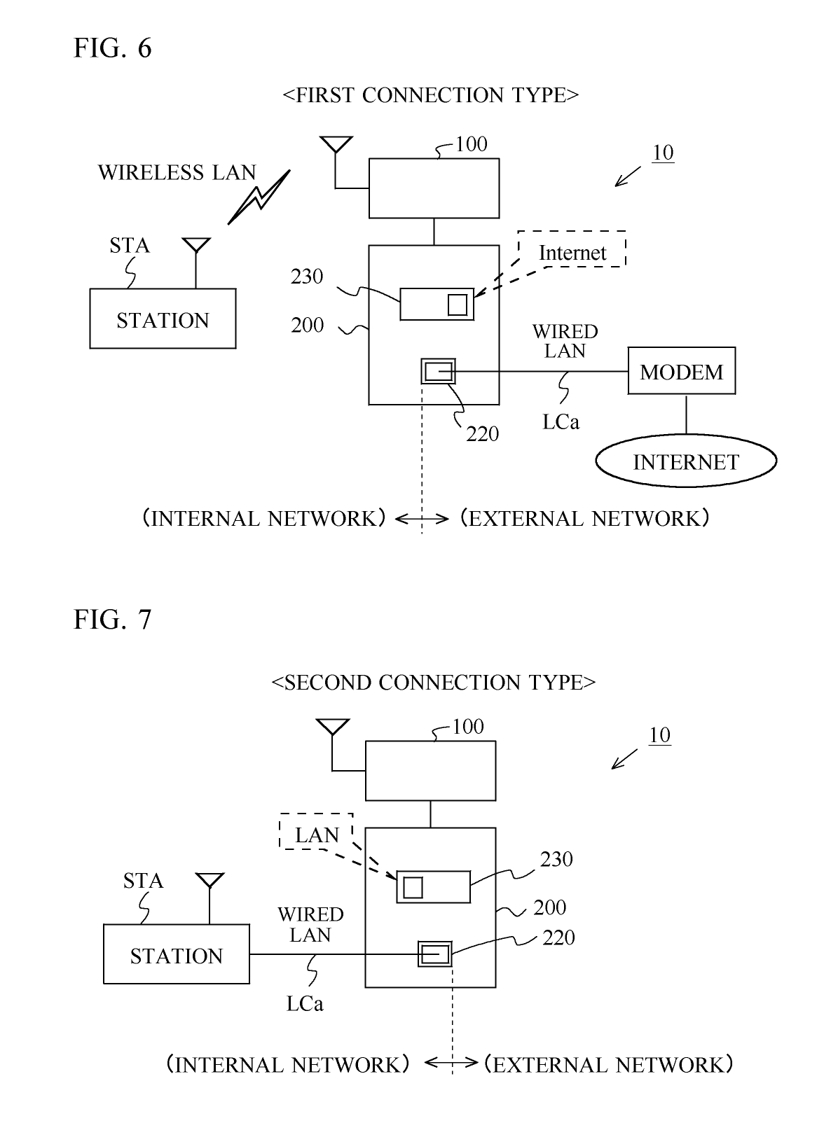

In FIG. 5, when the main unit 100 is powered on, and a LAN cable LCa (FIG. 6) is connected to the port 220 to form a network link (linkup between the port 220 and a network), the operation-mode switching process according to the first embodiment starts in the main unit 100. The transfer control section 122 monitors via the connection monitoring section 126 whether the main unit 100 and the cradle 200 are connected, and waits until a connection between the main unit 100 and the cradle 200 is established (step S105). When the main unit 100 and the cradle 200 have been connected (Yes in step S105), the transfer control section 122 loads an Ethernet driver program stored in the ROM 171 into the LAN control circuit 210 included in the cradle 200 (step S110). Thereafter, the transfer control section 122 determines via the switch monitoring section 123 whether the switch 230 is in the “Internet” state (external connection state), which indicates the state of being in connection with an external network, or in the “LAN” state (internal connection state), which indicates the state of being in connection with an internal network (step S115). If the switch 230 is in the “Internet” state, the transfer control section 122 switches the operation mode of the transfer process section 121 to a first operation mode (step S120), whereas if the switch 230 is in the “LAN” state, the transfer control section 122 switches the operation mode of the transfer process section 121 to a second operation mode (step S125).

When the device is switched into the first operation mode by means of the switch 230, a later-described first connection type will be established as the type of connection by the wireless relay device 10, and when the device is switched into the second operation mode, one of later-described second to fourth connection types will be established as the type of connection by the wireless relay device 10. Users can establish a desired connection type from among the first to fourth connection types by switching the state of the switch 230.

With further reference to FIGS. 6 to 13, the first to fourth connection types, which are realized in wireless communications by the wireless relay device 10 having the above-described configuration, will be described. FIGS. 6 to 9 are diagrams respectively illustrating the first to fourth connection types which are realized in wireless communications by the wireless relay device 10. FIGS. 10 to 13 are diagrams schematically illustrating a packet transfer path in the wireless relay device 10 in the first to fourth connection types illustrated in FIGS. 6 to 9. It will be appreciated that some of the components included in the wireless relay device 10 are not illustrated in FIGS. 10 to 13.

First Connection Type

The first connection type, established in the first operation mode will be described. As illustrated in FIG. 6, in the first connection type, the main unit 100 is connected to the cradle 200, and an end of a LAN cable LCa, which is a network cable and whose other end is connected to, for example, an FTTH modem or a DSL modem, is connected to the port 220 of the cradle 200. The switch 230 of the cradle 200 is set to the “Internet” state, which is the first operation mode. In the first connection type, the wireless relay device 10 functions as an access point for a wireless LAN station STA, and carries out wireless communications with the station STA via the wireless LAN control circuit 174. That is, in the first connection type, the station STA can access the Internet via the wireless relay device 10 and a modem.

As illustrated in FIG. 6, in the first connection type, the internal network, which the station STA belongs to, is a segment that includes a wireless LAN zone. On the other hand, the external network, which the station STA does not belong to, is a segment that includes the port 220 and a wired LAN zone.

FIG. 10 illustrates a packet transfer path in the wireless relay device 10 in the first connection type. Upon transmission of a packet (Layer 2 frame) from a station STA via the wireless LAN, the wireless LAN control circuit 174 receives the packet and transfers the packet to the bridge function section 121b. The bridge function section 121b transfers the received packet to the router function section 121r. The router function section 121r executes an address conversion process (NAT or IP Masquerade) to change the IP address of the transmission source of the transferred packet from a private IP address, which is preliminarily allocated to the station STA, to a global IP address. At this time, the PPPoE process section 124 adds a PPPoE header to the packet (IP packet), which has undergone the address conversion, to encapsulate the packet as a PPPoE frame. The encapsulated packet (PPPoE frame) is transmitted to the LAN control circuit 210 via the switch 230 set to “Internet” state. The LAN control circuit 210 generates a Layer 2 frame based on the packet received from the router function section 121r, and transmits a signal including the generated Layer 2 frame from the port 220 to the modem or the like.

Meanwhile, a signal, transmitted from the modem, containing data destined for the station STA arrives at the LAN control circuit 210 via the port 220. The LAN control circuit 210 assembles a packet (Layer 2 frame) based on the received signal, and transmits the packet to the router function section 121r via the switch 230 set to “Internet” state. The router function section 121r assembles an IP packet based on the Layer 2 frame from the received packet, and transfers the IP packet to the bridge function section 121b based on the IP address of the destination. The bridge function section 121b transfers the received packet to the wireless LAN control circuit 174. The wireless LAN control circuit 174 transmits the received packet (Layer 2 frame) to the station STA via the wireless LAN.

As described above, the first operation mode using the first connection type enables wireless communications between the station STA and the wireless relay device 10 via the wireless LAN control circuit 174, and also enables wired communications between a network device (such as a modem) and the wireless relay device 10 via the LAN cable LCa connected to the port 220. Therefore, in the first operation mode, the port 220 functions as the external-network-side-port in the wireless relay device 10. In this embodiment, the external network means a network (segment) which the station STA does not belong to, i.e., a network to which a global IP address is added. In other words, the external network means a network that is associated with the port through which, among the ports for the router function section 121r, the PPPoE process is executed.

Second Connection Type

A second connection type established in the second operation mode will be described. As illustrated in FIG. 7, in the second connection type, the main unit 100 is connected to the cradle 200, and an end of a LAN cable LCa, which is a network cable and whose other end is connected to a station STA, is connected to the port 220 of the cradle 200. In addition, the switch 230 of the cradle 200 is set to the “LAN” state, which is the second operation mode. In the second connection type, the wireless relay device 10 functions as a bridge for the wired LAN station STA, and carries out wired communications with the station STA. In other words, in the second connection type, the station STA is able to transfer/receive data to/from the wireless relay device 10. Thus, for example, the second connection type may be established when the station STA is operated to set various parameters in the main unit 100.

As illustrated in FIG. 7, in the second connection type, the internal network, which the station STA belongs to, is a segment that includes the port 220 and a wired LAN zone.

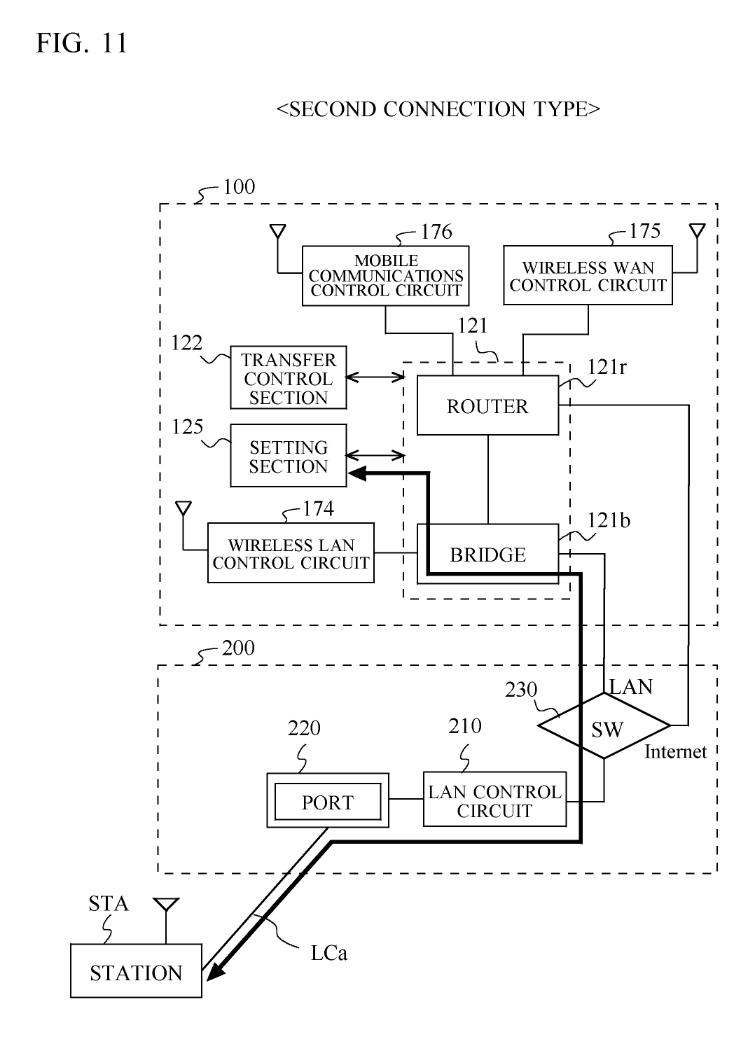

FIG. 11 illustrates a packet transfer path in the wireless relay device 10 in the second connection type. Upon transmission from the station STA, via the wired LAN (LAN cable LCa), of signals containing data (e.g., setting data) destined for the wireless relay device 10, the LAN control circuit 210 receives the signal via the port 220. The LAN control circuit 210 assembles a packet (Layer 2 frame) based on the received signal, and transmits the assembled packets to the bridge function section 121b via the switch 230 set to the “LAN” state. The destination MAC (Media Access Control) address of the Layer 2 frame is the MAC address of the wireless relay device 10 itself, and thus the bridge function section 121b does not transfer the received packet to the router function section 121r or other ports communicable with the bridge function section 121b, but transmits the received packet to the setting section 125 after extracting data from the packet. The setting section 125 sets various parameters based on the received data.

Further, if the received data includes an inquiry or the like about the setting data transmitted from the station STA, the setting section 125 assembles a packet (Layer 2 frame) including the setting data and transmits the packet to the bridge function section 121b. The bridge function section 121b transmits the received packet to the LAN control circuit 210 via the switch 230 set to the “LAN” state. The LAN control circuit 210 transmits a signal including the packet received from the bridge function section 121b from the port 220 to the station STA via the wired LAN (LAN cable LCa).

As described above, in the second operation mode in the second connection type, wired communications are carried out between the station STA and the wireless relay device 10 via the LAN cable LCa connected to the port 220. Therefore, in the second operation mode, the port 220 functions as an internal-network-side port in the wireless relay device 10. Accordingly, the user can perform setting of various parameters in the wireless relay device by using the station STA as being wiredly connected to the wireless relay device, whereby the user's convenience can be enhanced. In this embodiment, the internal network means a network (segment) that the station STA belongs to. In other words, the internal network means a network to which a private IP address is added, similarly to the station STA.

Third Connection Type

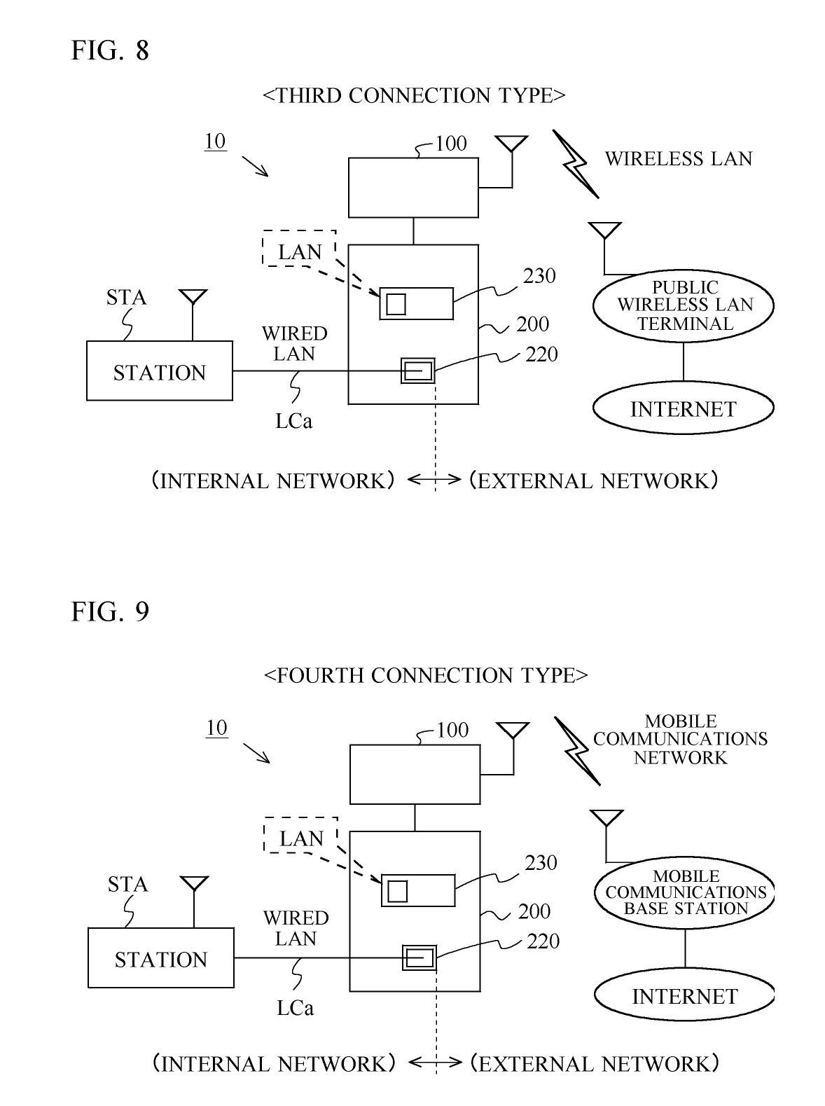

A third connection type established in the second operation mode will be described. As illustrated in FIG. 8, in the third connection type, the main unit 100 is connected to the cradle 200, and an end of a LAN cable LCa, which is a network cable whose other end is connected to a station STA, is connected to the port 220 of the cradle 200. Further, the switch 230 of the cradle 200 is set to the “LAN” state, which is the second operation mode. In the third connection type, the wireless relay device 10 functions as a client for an access point in a public wireless LAN (public wireless LAN terminal), and carries out wireless communications with the public wireless LAN terminal via the wireless WAN control circuit 175. That is, in the third connection type, the station STA is accessible to the Internet via the wireless relay device 10 and the public wireless LAN terminal without using a wireless communications interface.

As illustrated in FIG. 8, in the third connection type, the internal network, which the station STA belongs to, is a segment that includes the port 220 and a wired LAN zone. On the other hand, the external network, which the station STA does not belong to, is a segment that includes a public wireless LAN zone.

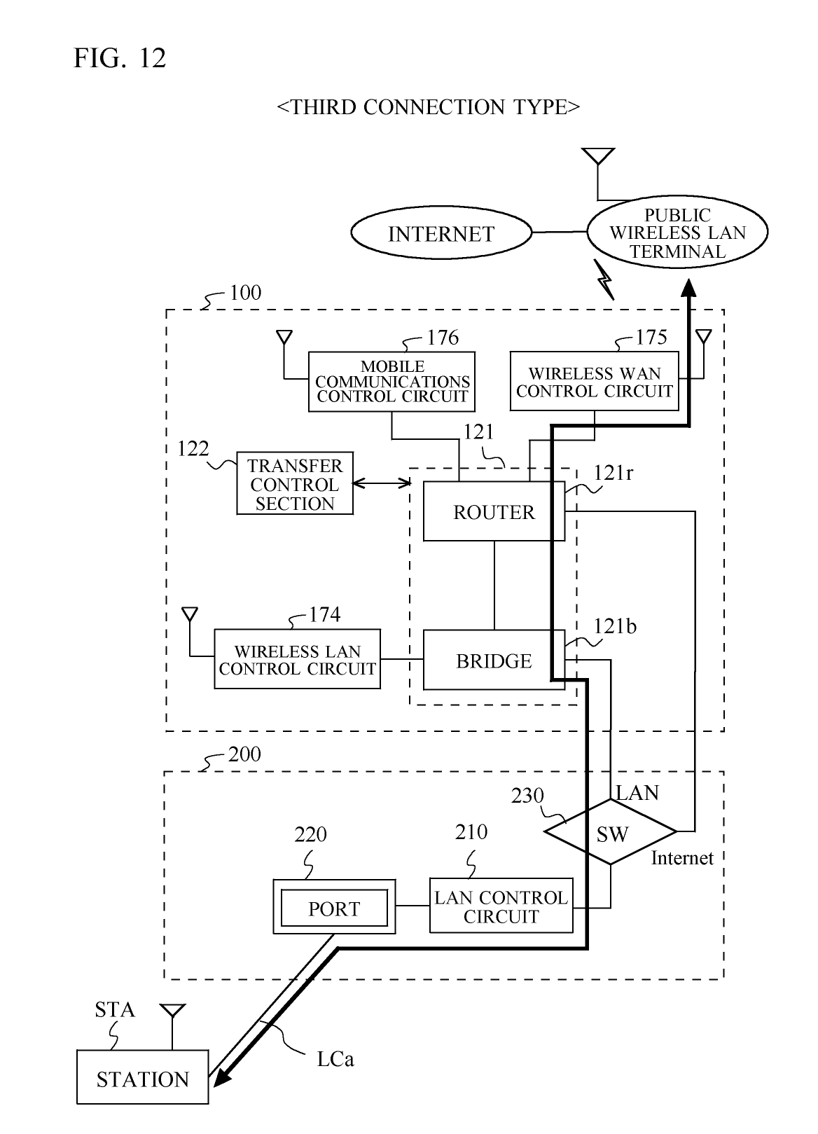

FIG. 12 illustrates a packet transfer path in the wireless relay device 10 in the third connection type. When a signal containing data destined for a device such as a terminal or a server, which is connected to the Internet via a wired LAN (LAN cable LCa) and is the public wireless LAN terminal in this case, is transmitted from the station STA to the wireless relay device 10, the LAN control circuit 210 receives the signal via the port 220. The LAN control circuit 210 assembles a packet (Layer 2 frame) based on the received signal, and transmits the assembled packet to the bridge function section 121b via the switch 230 set to the “LAN” state. Since the destination MAC address of the Layer 2 frame is not the MAC address of the wireless relay device 10 itself, the bridge function section 121b transfers the received packet to the router function section 121r. The router function section 121r transmits the received packet to the wireless WAN control circuit 175. The wireless WAN control circuit 175 transmits the packet (Layer 2 frame) to the public wireless LAN terminal as a public wireless LAN client.

Meanwhile, a packet (Layer 2 frame) transmitted from the public wireless LAN terminal destined for the station STA is received by the wireless WAN control circuit 175. The wireless WAN control circuit 175 then transfers the packet to the router function section 121r. The router function section 121r transfers the received packet to the bridge function section 121b. The bridge function section 121b transmits the received packet to the LAN control circuit 210 via the switch 230 which is set to the “LAN” state. Via the wired LAN (LAN cable LCa), the LAN control circuit 210 transmits a signal containing the packet received from the bridge function section 121b from the port 220 to the station STA.

As described above, the second operation mode in the third connection type enables wired communications between the station STA and the wireless relay device 10, via the LAN cable LCa connected to the port 220, and also enables wireless communications between a network device such as the public wireless LAN terminal and the wireless relay device 10 via the wireless WAN control circuit 175. Thus, in the third connection type, as in the second connection type, the second operation mode causes the port 220 to function as an internal-network-side port in the wireless relay device 10.

Fourth Connection Type

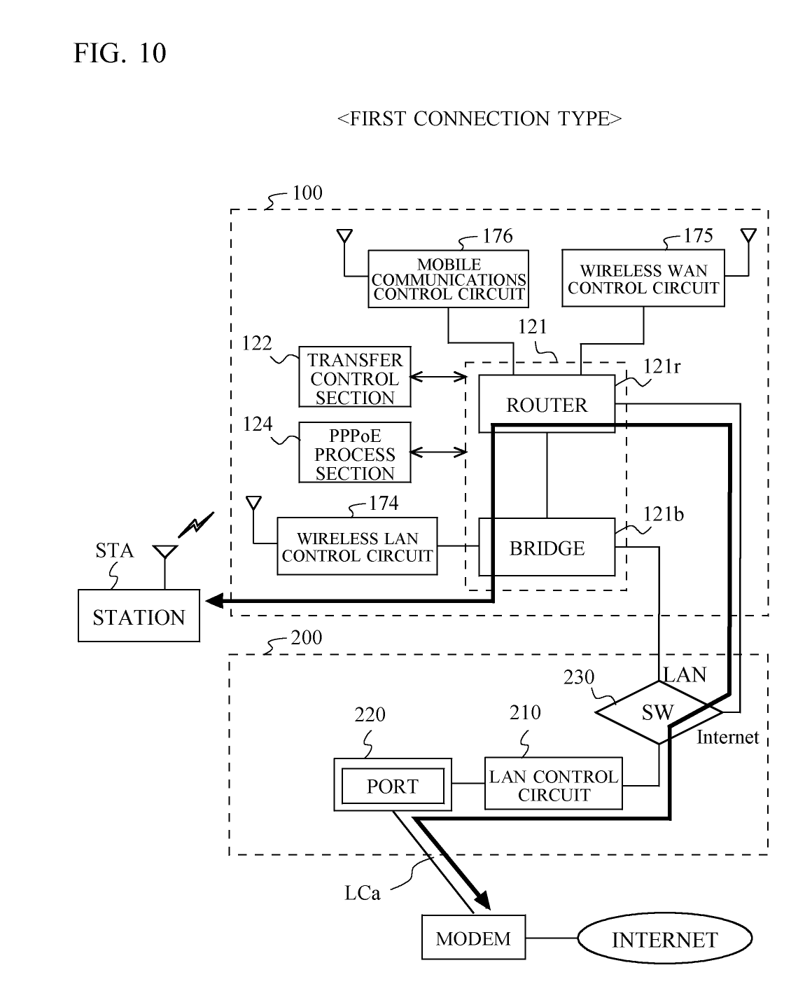

A fourth connection type established in the second operation mode will be described. As illustrated in FIG. 9, in the fourth connection type, the main unit 100 is connected to the cradle 200, and an end of a LAN cable LCa, which is a network cable and whose other end is connected to a station STA, is connected to the port 220 of the cradle 200. In addition, the switch 230 of the cradle 200 is set to the “LAN” state, which is the second operation mode. In the fourth connection type, the wireless relay device 10 functions as a client for an access point in a mobile communications network (mobile communications terminal), and carries out wireless communications (mobile communications) with a mobile communications base station via the mobile communications control circuit 176. That is, in the fourth connection type, the station STA can access the Internet via the wireless relay device 10 and the mobile communications base station without using a wireless communications interface.

As illustrated in FIG. 9, in the fourth connection type, the internal network, which the station STA belongs to, is a segment that includes the port 220 and a wired LAN zone. On the other hand, the external network, which the station STA does not belong to, is a segment that includes a mobile communications network zone.

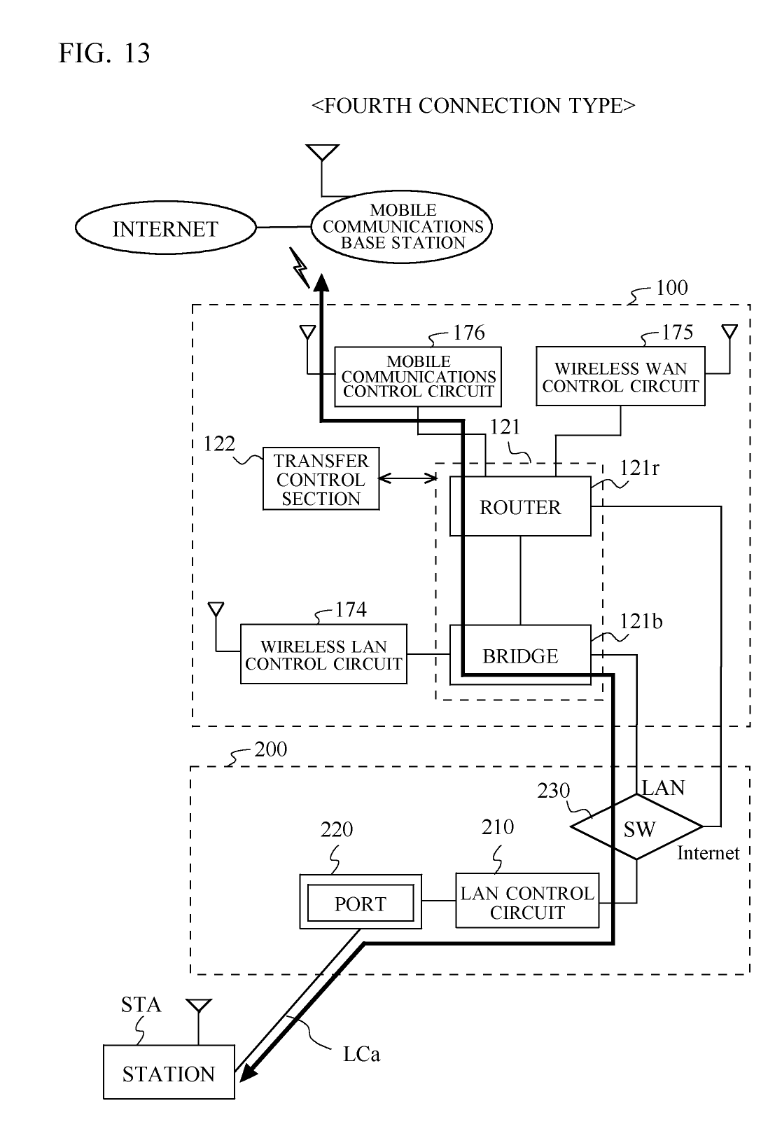

FIG. 13 illustrates a packet transfer path in the wireless relay device 10 in the fourth connection type. When a signal including data destined for a device such as a terminal or a server, which is connected to the Internet via a wired LAN (LAN cable LCa) and is the mobile communications base station in this case, is transmitted from the station STA to the wireless relay device 10, the LAN control circuit 210 receives the signal via the port 220. The LAN control circuit 210 assembles a packet (Layer 2 frame) based on the received signal, and transmits the packet to the bridge function section 121b via the switch 230 set to the “LAN” state. Since the destination MAC address of the Layer 2 frame is not the MAC address of the wireless relay device 10 itself, the bridge function section 121b transfers the received packet to the router function section 121r. The router function section 121r transfers the received packet to the mobile communications control circuit 176. The mobile communications control circuit 176 transmits the packet (Layer 2 frame) to the mobile communications base station as a client in the mobile communications network.

Meanwhile, a packet (Layer 2 frame) transmitted from the mobile communications base station destined for a station STA is received by the mobile communications control circuit 176. The mobile communications control circuit 176 then transfers the packet to the router function section 121r. The router function section 121r transfers the received packet to the bridge function section 121b. The bridge function section 121b transmits the received packet to the LAN control circuit 210 via the switch 230 et to the “LAN” state. The LAN control circuit 210 transmits from the port 220 a signal containing the packet received from the bridge function section 121b to the station STA via the wired LAN (LAN cable LCa).

As described above, the second operation mode in the fourth connection type enables wired communications between the station STA and the wireless relay device 10, via the LAN cable LCa connected to the port 220, and also enables wireless communications between the wireless relay device 10 and a network device such as the mobile communications base station, via the mobile communications control circuit 176. Therefore, in the fourth connection type, as in the above-described second and third connection types, the second operation mode causes the port 220 to function as an internal-network-side port in the wireless relay device 10.

It should be noted that the reason why the destination of packets assembled by the LAN control circuit 210 differ between the first connection type (FIG. 10), and the third and fourth connection types (FIG. 12 and FIG. 13) is as follows. In the third and fourth connection types, if the configuration is such that a packet is transferred from the LAN control circuit 210 to the router function section 121r, then two user-side networks (segments) will be existent. In other words, two segments—i.e., a segment that the station STA belongs to in the first connection type, and a segment that the station STA belongs to in the third and fourth connection types—exist. In this case, it is necessary to set various parameters in the wireless relay device 10 and the station STA for the respective segments, which imposes a large burden on the users. Thus, in this embodiment, in the case of the third and fourth connection types in which the port 220 functions as an internal-network-side port, packets from the LAN control circuit 210 are transferred to the bridge function section 121b, whereby a single user-side network (segment) is established, and consequently the user's convenience is improved.

As described above, the wireless relay device 10, which carries out the operation-mode switching process according to the first embodiment, causes the port 220 to function as an external-network-side port (in the segment which a station STA does not belong to) or an internal-network-side port (in the segment which a station STA belongs to) depending on the setting state of the switch 230. Thus, the port 220 can be used either as an external-network-side port or as an internal-network-side port.

When the port 220 is caused to function as an internal-network-side port, wired connection between the wireless relay device 10 and a station STA is enabled. Thus, it is possible to set various parameters to the wireless relay device 10 by operating the station STA wiredly connected to the wireless relay device 10, which enhances the user's convenience. Further, with the wired connection between the station STA and the wireless relay device 10, the wireless relay device 10 can be connected to a public wireless LAN or a mobile communications network. In this case, only a wired LAN interface is required, and consequently, a station STA without a wireless communications interface can be connected to the Internet via a public wireless LAN or a mobile communications network.

In addition, when the port 220 is caused to function as an external-network-side port, wired connection between the wireless relay device 10 and a modem, for example, is enabled. Accordingly, if a station STA is a wireless LAN client, the wireless relay device 10 can be used to function as a wireless LAN access point.

In this embodiment, a single port 220 can function as an internal-network-side port or an external-network-side port through switching therebetween, and thus the wireless relay device 10 according to this embodiment can be downsized as compared to the conventional device configuration in which both an internal-network-side port (physical port) and an external-network-side port (physical port) are arranged. Further, it is not necessary for the wireless relay device 10 according to this embodiment to control multiple ports, and thus the LAN control circuit 210 can be configured with an inexpensive circuit, which can prevent manufacturing cost increase.

Further, in the wireless relay device 10 according to this embodiment, the switch 230 as well as the port 220 is arranged in the cradle 200, and thus the user can easily perform the operation of switching the state of the switch 230 concurrently with the operation of wiring a LAN cable LCa to change the connection type. In other words, the user can switch the state of the switch 230 without fail when the user connects an end of a LAN cable LCa to the port 220 of the cradle 200. Further, since the switch 230 and the port 220 are arranged in the cradle 200, a small, lightweight main unit 100 can be realized.

### (2) Second Embodiment

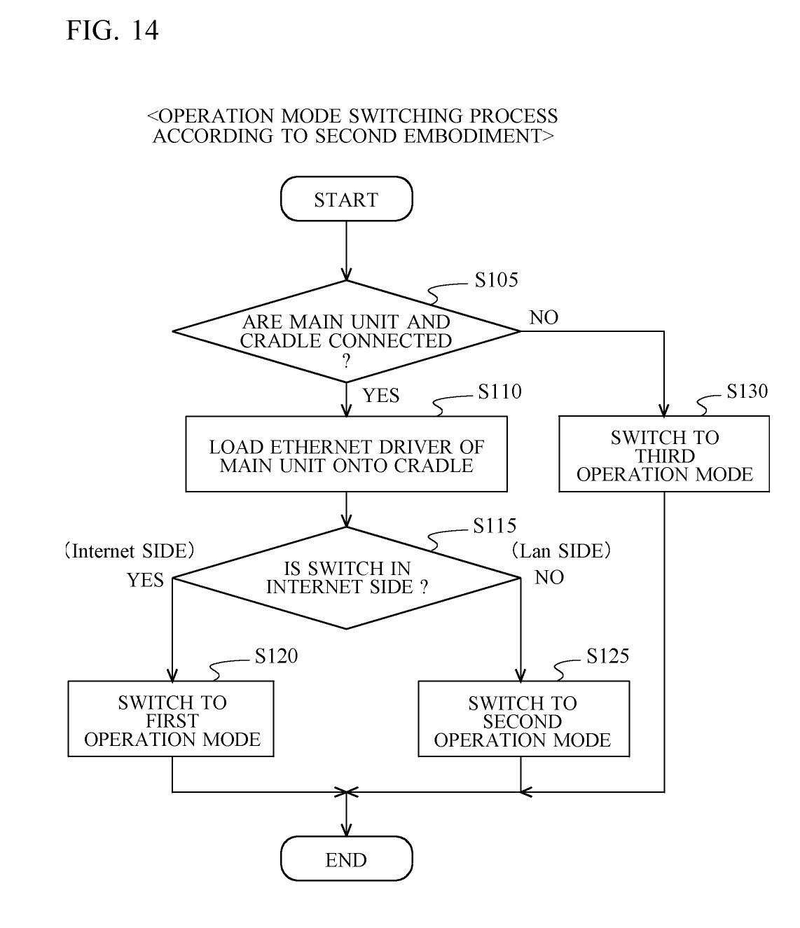

The above first embodiment describes the configuration in which the main unit 100 is connected to the cradle 200. This second embodiment will describe a connection type which causes a station STA to establish a connection with the Internet even in the case where the main unit 100 is not connected to the cradle 200. FIG. 14 is a flowchart showing the procedure of an operation-mode switching process according to the second embodiment performed by the wireless relay device 10.

As shown in FIG. 14, if the main unit 100 and the cradle 200 are not connected (No in step S105) when the operation-mode switching process according to the second embodiment has started in the main unit 100, the transfer control section 122 switches the operation mode of the transfer process section 121 to a third operation mode (step S130), which is a procedure different from the operation-mode switching process according to the first embodiment (FIG. 5). The switching to the third operation mode is carried out irrespective of the state of the switch 230. If the main unit 100 and the cradle 200 are connected, the process therefor is the same as the operation-mode switching process according to the first embodiment, and thus no description thereof will be given. When the transfer control section 122 switches the operation mode to the third operation mode, a fifth connection type described below is formed in the wireless relay device 10.

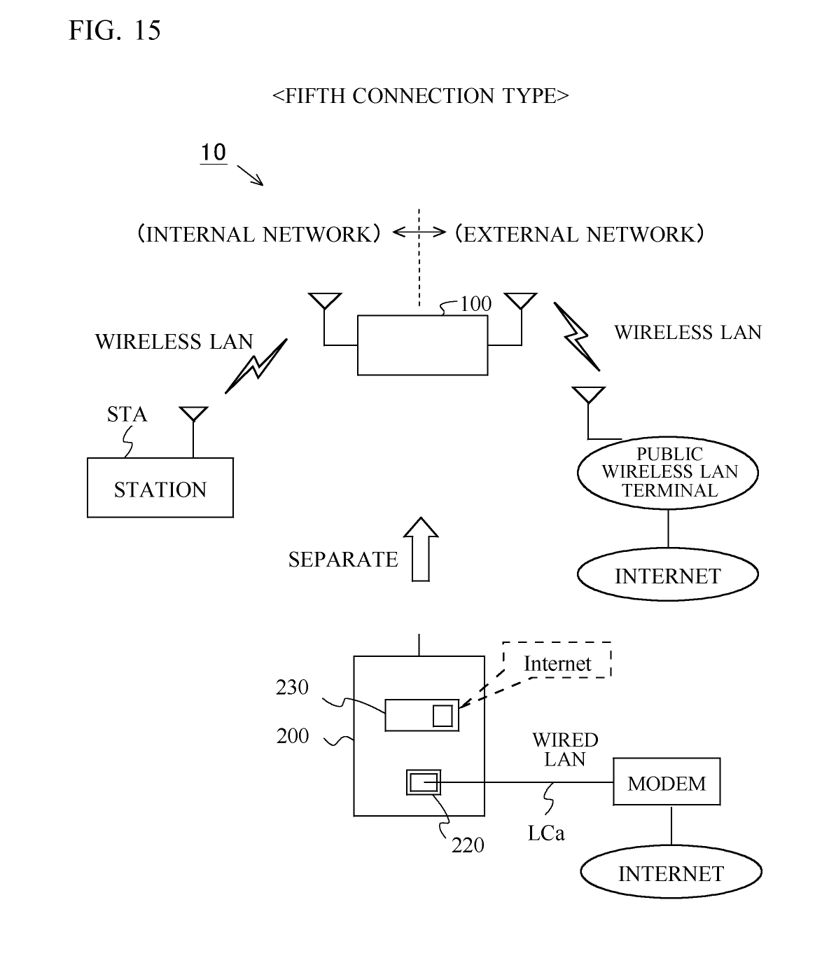

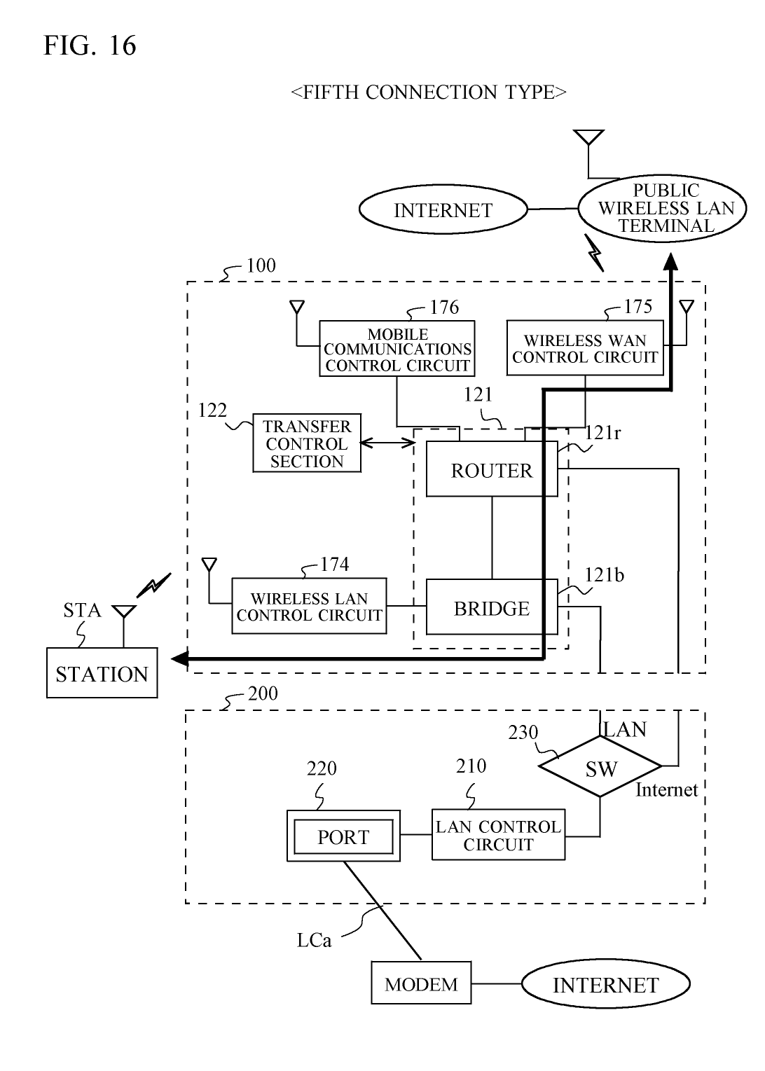

FIG. 15 is a diagram illustrating the fifth connection type of the wireless relay device 10 which is carrying out wireless communications. FIG. 16 is a diagram schematically illustrating a packet transfer path in the wireless relay device 10 using the fifth connection type. In FIG. 16, some of the components included in the wireless relay device 10 are not illustrated.

Fifth Connection Type

A fifth connection type formed in the third operation mode will be described. As illustrated in FIG. 15, in the fifth connection type, the main unit 100 is removed from the cradle 200. In this case, it is unnecessary to consider a device wiredly connected to the port 220 of the cradle 200 via a LAN cable LCa and the state of the switch 230. In the fifth connection type, the wireless relay device 10 functions as an access point for a wireless LAN station STA, and carries out wireless communications with the station STA via the wireless LAN control circuit 174. Also, the wireless relay device 10 functions as a client for a public wireless LAN access point (public wireless LAN terminal), and carries out wireless communications with the public wireless LAN terminal via the wireless WAN control circuit 175. That is, in the fifth connection type, the station STA is accessible to the Internet via the wireless relay device 10 and the public wireless LAN terminal.

FIG. 16 illustrates a packet transfer path in the wireless relay device 10 using the fifth connection type. When a packet (Layer 2 frame) is transmitted from the station STA via the wireless LAN, the wireless LAN control circuit 174 receives and then transfers the packet to the bridge function section 121b. The bridge function section 121b transfers the received packet to the router function section 121r. The router function section 121r transmits the received packet to the wireless WAN control circuit 175. The wireless WAN control circuit 175 transmits, as a public wireless LAN client, the packet (Layer 2 frame) to the public wireless LAN terminal (access point).

Meanwhile a packet (Layer 2 frame) transmitted from the public wireless LAN terminal destined to the station STA is received by the wireless WAN control circuit 175, and the wireless WAN control circuit 175 transfers the packet to the router function section 121r. The router function section 121r transfers the received packet to the bridge function section 121b. The bridge function section 121b transmits the received packet to the wireless LAN control circuit 174. The wireless LAN control circuit 174 transmits the received packet (Layer 2 frame) to the station STA via the wireless LAN.

As described above, in the third operation mode using the fifth connection type, wireless communications are carried out between the station STA and the wireless relay device 10 via the wireless LAN control circuit 174, and wireless communications are also carried out between the wireless relay device 10 and a network device such as the public wireless LAN terminal via the wireless WAN control circuit 175.

As described above, in the wireless relay device 10 carrying out the operation-mode switching process according to the second embodiment, when the main unit 100 is connected to the cradle 200, the same connection types are formed for the wireless relay device 10 to carry out the operation-mode switching process as in the first embodiment, whereas if the main unit 100 is separated from the cradle 200, an internal network (segment) which a station STA belongs to is connected to an external network (segment) which the wireless WAN control circuit 175 belongs to.

It should be noted that, as illustrated in FIG. 15, if the switch 230 is set to the “Internet” state, and the port 220 is connected to a modem via a LAN cable LCa preliminarily, the following manner of usage may be possible. When the main unit 100 is connected to the cradle 200, the first operation mode using the first connection type enables connection between the internal network and the external network, whereas when the main unit 100 is not connected to the cradle 200, the third operation mode using the fifth connection type enables connection between the internal network and the external network. That is, when the main unit 100 is connected to the cradle 200, the Internet connection is established via a public wireless LAN, whereas when the main unit 100 is separated from the cradle 200, the Internet connection established via a wired LAN. Accordingly, for example, at home, a user can establish a connection between a station STA and the Internet using the first connection type, whereas at an outside (at a station or a restaurant), a user can carry the main unit 100 separated from the cradle 200 and establish a connection between a station STA and the Internet using the fifth connection type. That is, depending on how the main unit 100 is to be used, the connection type can be changed automatically. Thus, it is possible to provide a wireless relay device that can realize not only highly reliable and faster communications at home but also simple communications at an outside, and that improve the convenience of the users.

Modification 1

The configuration of the wireless relay device 10 according to the above-described embodiments is a mere example, and various modifications are possible. For example, in the above-described embodiments, the cradle connection interface 180 of the main unit 100 and the main unit connection interface 280 of the cradle 200 transmit/receive information to/from each other in accordance with the USB standard. However, transmission/reception of information between the main unit 100 and the cradle 200 may be performed in accordance with other standard than the USB standard. In this case, the main unit 100 may include an interface compliant with such other standard than the USB device interface 173.

Modification 2

Further, in the above embodiments, the wireless LAN control circuit 174 and the wireless WAN control circuit 175 may be configured to perform wireless communications compliant with a wireless LAN standard which may be applicable in the future, instead of the wireless communications compliant with the IEEE 802.11a/b/g/n standard. Further, the mobile communications control circuit 176 may be configured to perform wireless communications compliant with a mobile communications standard which may be applicable in the future, such as a LTE, a next generation mobile WiMAX (IEEE 802.16m), and a next generation PHS (XGP: eXtended Global Platform) instead of the mobile communications compliant with the 3G/HSPA standard.

Modification 3

Further, in the above embodiments, three types of components, i.e., the wireless LAN control circuit 174, the wireless WAN control circuit 175, and the mobile communications control circuit 176 have been described as the wireless communications interface included in the main unit 100. However, the main unit 100 may include other types of wireless communications interfaces than these three types. Alternatively, the main unit 100 may include any number of wireless communications interfaces, i.e., one, two, or four interfaces, or wireless communications interfaces of a single type.

Modification 4

In the above embodiments, the cradle 200 is provided with a single port 220. However, the cradle 200 may be provided with a plurality of ports. For example, if the cradle 200 is provided with a plurality of ports, the switching process by the switch 230 of selectively switching between the “Internet” state and the “LAN” state may be applied to all the ports, or some of the ports. In the latter case, those ports to which the switching process is not applied may be fixedly used as either the internal network port or the external network port.

Modification 5

In the above embodiments, when the state is switched to the second operation mode, the wireless relay device 10 may form any of the second to fourth connection types. However, the connection type that the wireless relay device 10 can form may be limited. For example, the wireless relay device 10 may be configured to form the second connection type unconditionally when the operation mode is switched to the second operation mode. In this configuration, the wireless WAN control circuit 175 and the mobile communications control circuit 176 may be removed from the main unit 100.

Modification 6

In the above embodiments, the wireless relay device 10 is configured with the main unit 100 and the cradle 200 which are detachably connectable to each other. However, the main unit 100 and the cradle 200 may have an integrated structure which does not allow detachment. The integrated structure is not applicable to the second embodiment.

Modification 7

In the above embodiments, the switch 230 is provided to the cradle 200. However, the switch 230 may be provided to the main unit 100. With this structure, it is unnecessary to wire a control line between the main unit 100 and the cradle 200 to notify the CPU 120 of the state of the switch 230. Thus, the configuration of the cradle connection interface 180 and the main unit connection interface 280 can be simplified.

Modification 8

In the above embodiments, a slide switch is applied as the switch 230. However, any type of switch other than the slide switch may be used as the switch 230. For example, the switch 230 may be any physical switch such as a press button switch, and a rotary switch. Alternatively, for example, a display section and an operation panel may be provided to the main unit 100 or the cradle 200 to use them as a logical switch, where a menu displayed on the display section is selected through operation of the operation panel thereby to switch the function of the port 220. Alternatively, for example, a GUI (Graphical User Interface), which is provided by a switching program activated in a station STA connected to the wireless relay device 10, may be used as a logical switch for switching the function of the port 220.

Modification 9

In the above embodiments, in the second to fourth connection types in the second operation mode, the station STA and the port 220 of the cradle 200 are connected via a LAN cable LCa only. However, other component than the LAN cable LCa may be interposed between the station STA and the port 220. For example, a bridge (e.g., Layer 2 switch) or a repeater (e.g., repeater hub) may be arranged between the station STA and the port 220 to establish a connection between the station STA and the port 220 via the bridge or the repeater. In such a configuration, the station STA and the wireless relay device 10 (LAN control circuit 210) belong to the same segment. It should be noted that the segment corresponds to an internal network in the claims.

Modification 10

In the above embodiments, in the fifth connection type in the third operation mode, the wireless relay device 10 carries out, as a client for a public wireless LAN access point, wireless communications with a public wireless LAN terminal via the wireless WAN control circuit 175. However, in the fifth connection type, the wireless relay device 10 may carry out, as a client for a mobile communications network access point, wireless communications with a mobile communications base station via the mobile communications control circuit 176.

Modification 11

In the above embodiments, in the first connection type in the first operation mode, the router function section 121r of the wireless relay device 10 performs address conversion between the private IP address and the global IP address. However, there may be a case where the router function section 121r need not perform address conversion. For example, if a global IP address is allocated to a station STA, or if an external network is a network (LAN) that belongs to a segment different from that including a wireless LAN and is allocated with a private IP address, then the address conversion is not required. Further, if an external network is a network (LAN) that belongs to a segment different from that including a wireless LAN, and is allocated with a private IP address, then the PPPoE process in the wireless relay device 10 can also be removed.

As is clear from the above first and second embodiments and Modifications 1 to 11, in the above-exemplified wireless relay device 10 of the present invention, the internal network represents a network that at least a client belongs to, and the external network represents a network that at least a client does not belong to.

Further, in the above embodiments, the CPU 120 controls the respective components of the wireless relay device 10 by extracting firmware or a computer program stored in the ROM 171 onto the RAM 172 and executing the firmware or the program. However, the components of the present invention may be realized by hardware as appropriate, or may be realized by software. Further, when some or all the functions of the present invention are realized by software, the software (computer program) may be provided in a manner as to be stored in a computer-readable storage medium. In the present invention, the “computer-readable storage medium” includes not only a portable storage medium such as a flexible disk and a CD-ROM, but also an internal storage device such as a RAMs and a ROM, and an external storage device fixed to computers such as a hard disk.

While the invention has been described in detail, the foregoing description is in all aspects illustrative and not restrictive. It will be understood that numerous other modifications and variations can be devised without departing from the scope of the invention.

What is claimed is:

1. A wireless relay device communicable with an internal network to which one or more stations belong and with an external network to which the stations do not belong, the wireless relay device comprising:
a port for connection with a network cable;
a switch for switching between an external connection state in which the port is used as a port on the external-network side, and an internal connection state in which the port is used as a port on the internal-network side; and
a transfer process section for switching packet transfer operations in accordance with the state of the switch.

2. The wireless relay device according to claim 1, further comprising:
an internal-network-side wireless communications interface, belonging to the internal network, for carrying out wireless communications with one or more stations, wherein
the transfer process section is configured to
operate, when the switch is in the external connection state, in a first operation mode, in which the transfer process section carries out packet transfer between a station as being connected to the wireless relay device via the internal-network-side wireless communications interface, and a network device belonging to the external network and connected to the port via a network cable, and
operate, when the switch is in the internal connection state, in a second operation mode, in which the transfer process section carries out packet transfer between the wireless relay device and a station as being connected to the port via a network cable.

3. The wireless relay device according to claim 2, further comprising:
an external-network-side wireless communications interface, belonging to the external network, for carrying out wireless communications with a network device belonging to a predetermined wireless communications network, wherein
the transfer process section carries out packet transfer, in the second operation mode, between a station as being connected to the port via a network cable, and a network device connected to the wireless relay device via the external-network-side wireless communications interface.

4. The wireless relay device according to claim 2, further comprising:
a main unit; and
an attachment detachably connectable to the main unit, wherein
the internal-network-side wireless communications interface is disposed in the main unit, and
the port and the switch are disposed in the attachment.

5. The wireless relay device according to claim 3, further comprising:
a main unit; and
an attachment detachably connectable to the main unit, wherein
the internal-network-side wireless communications interface and the external-network-side wireless communications interface are disposed in the main unit, and the port and the switch are disposed in the attachment.

6. The wireless relay device according to claim 5, further comprising
a determination section for determining whether the main unit is connected to the attachment, wherein
the transfer process section operates, when the determination section determines that the main unit is not connected to the attachment, in a third operation mode in which the transfer process section transfers a packet between a station as being connected to the wireless relay device via the internal-network-side wireless communications interface, and a network device connected to the wireless relay device via the external-network-side wireless communications interface.

7. The wireless relay device according to claim 3, wherein
the predetermined wireless communications network is a public wireless LAN or a mobile communications network.

8. The wireless relay device according to claim 5, wherein
the predetermined wireless communications network is a public wireless LAN or a mobile communications network.

9. The wireless relay device according to claim 6, wherein
the predetermined wireless communications network is a public wireless LAN or a mobile communications network.

10. A relay device switchable between wireless LAN to wired WAN and wired LAN to wireless WAN comprising:
a transfer process section having routing and bridging functions, and a packet-transfer control function interactive with and controlling the routing and bridging functions;
a wireless LAN communications interface;
a wireless WAN communications interface;
a single Ethernet port; and
a switch connected to said Ethernet port and to the routing and bridging functions of said transfer process section, and switchable between wireless LAN to wired WAN and wired LAN to wireless WAN operating states of the relay device; wherein
when said switch is in the wireless LAN to wired WAN operating state of the relay device, the packet-transfer control function of said transfer process section sets up a packet-transfer path whereby
incoming data packets via a wired WAN connection to said Ethernet port are sent in order from said Ethernet port through said switch, the routing function, the bridging function, and the wireless LAN communications interface, while incoming data packets via the wireless LAN communications interface are sent in order through the bridging function, the routing function, said switch and said Ethernet port, and
when said switch is in the wired LAN to wireless WAN operating state of the relay device, the packet-transfer control function of said transfer process section sets up a packet-transfer path whereby
incoming data packets via a wired LAN connection to said Ethernet port are sent in order from said Ethernet port through said switch, the bridging function, the routing function, and the wireless WAN communications interface, while incoming data packets via the wireless WAN communications interface are sent in order through the routing function, the bridging function, said switch and said Ethernet port.
